(19) United States
(12) Patent Application Publication
(10) Pub. No.: US 2015/0095345 A1
(43) Pub. Date: Apr. 2, 2015

(54) INFORMATION PROCESSING DEVICE

(71) Applicant: NEC CORPORATION, Tokyo (JP)

(72) Inventor: ICHIRO ARAI, TOKYO (JP)

(21) Appl. No.: 14/494,644

(22) Filed: Sep. 24, 2014

(30) Foreign Application Priority Data
Sep. 30, 2013 (JP) 2013-203790

(51) Int. Cl. G06F 17/30

(52) U.S. Cl. CPC G06F 17/30321
USPC 707/744

(57) ABSTRACT

The information processing system includes a data management unit that manages a group of records having a plurality of attribute values in a data structure including an index key-value pair and a record key-value pair associated with each other. The data management unit is configured to generate the index key-value pair including a value including a classification reference value indicating a criterion for classifying given attribute values included in the group of records, and a key associated with the value, and also generate the record key-value pair including a key associated with the classification reference value in the value of the index key-value pair, and a value including information of the records having the given attribute values corresponding to the classification reference value.

### INCORPORATION BY REFERENCE

The present invention is based upon and claims the benefit of priority from Japanese patent application No. 2013-203790, filed on Sep. 30, 2013, the disclosure of which is incorporated herein in its entirety by reference.

### TECHNICAL FIELD

The present invention relates to an information processing device, and in particular, to an information processing system in which data is managed using a key-value store approach.

### BACKGROUND ART

In recent years, as a platform for running scalable web applications, a cloud computing technology using a number of computers in a data center has attracted attention. As one of the infrastructures of the cloud computing technology, key-value store (KVS) which handles a pair of key and value (key-value pair; KV pair) as data has been known (see Patent Documents 1 and 2, for example). The data structure of a KV pair described in Patent Documents 1 and 2 is configured such that one key K is associated with a value V having only one unit of data (record R), as shown in FIG. 1.
Patent Document 1: JP 2013-25453 A
Patent Document 2: JP 2011-8451 A

Meanwhile, when a request source such as a client attempts to acquire a record from a node device, in KVS, a record acquisition request including a key corresponding to the record to be acquired is transmitted from the request source to the node device. Accordingly, in the technology described in Patent Documents 1 and 2 in which only one record is held with respect to one key, in the case of acquiring a plurality of related records, record acquisition requests must be transmitted a plurality of times from the request source to the node device. This causes a problem of a decrease in the network transfer efficiency.

In order to solve such a problem, as a data structure of a KV pair, adopting a structure in which one key K is associated with a value V having a plurality of related records R, as shown in FIG. 2, may be considered. By adopting such a data structure, a request source is able to acquire a plurality of related records by transmitting a record acquisition request only once to the node device. This improves the network transfer efficiency.

However, in the case of adopting the above-described data structure, if the number of records included in one KV pair increases, the size of one KV pair becomes large, whereby unnecessary records may be included in the acquired group of records, which causes a problem of a decrease in the processing efficiency.

### SUMMARY

Therefore, an exemplary object of the present invention is to provide an information processing device capable of solving the above-described problem, that is, a decrease in the processing efficiency in the case of adopting a key-value store approach.

An information processing device, which is an exemplary aspect of the present invention, is configured to include a data management unit that manages a group of records having a plurality of attribute values in a data structure including an index key-value pair and a record key-value pair associated with each other, wherein

the data management unit generates the index key-value pair including a value including a classification reference value indicating a criterion for classifying given attribute values included in the group of records, and a key associated with the value, and also generates the record key-value pair including a key associated with the classification reference value in the value of the index key-value pair, and a value including information of the records having the given attribute values corresponding to the classification reference value.

Further, a program, which is another exemplary aspect of the present invention, is a program for causing an information processing device to realize

a data management unit that manages a group of records having a plurality of attribute values in a data structure including an index key-value pair and a record key-value pair associated with each other, wherein

the data management unit generates the index key-value pair including a value including a classification reference value indicating a criterion for classifying given attribute values included in the group of records, and a key associated with the value, and also generates the record key-value pair including a key associated with the classification reference value in the value of the index key-value pair, and a value including information of the records having the given attribute values corresponding to the classification reference value.

Further, a data management method, which is another exemplary aspect of the present invention, is configured to include:

in an information processing device, when managing a group of records having a plurality of attribute values in a data structure including an index key-value pair and a record key-value pair associated with each other,

generating the index key-value pair including a value including a classification reference value indicating a criterion for classifying given attribute values included in the group of records, and a key associated with the value, and

also generating the record key-value pair including a key associated with the classification reference value in the value of the index key-value pair, and a value including information of the records having the given attribute values corresponding to the classification reference value.

With the configuration described above, the present invention is able to improve data processing performance in the case of adopting a key-value store approach.

### BRIEF DESCRIPTION OF DRAWINGS

FIG. 1 is a diagram showing an exemplary data structure of key-value store related to the present invention;

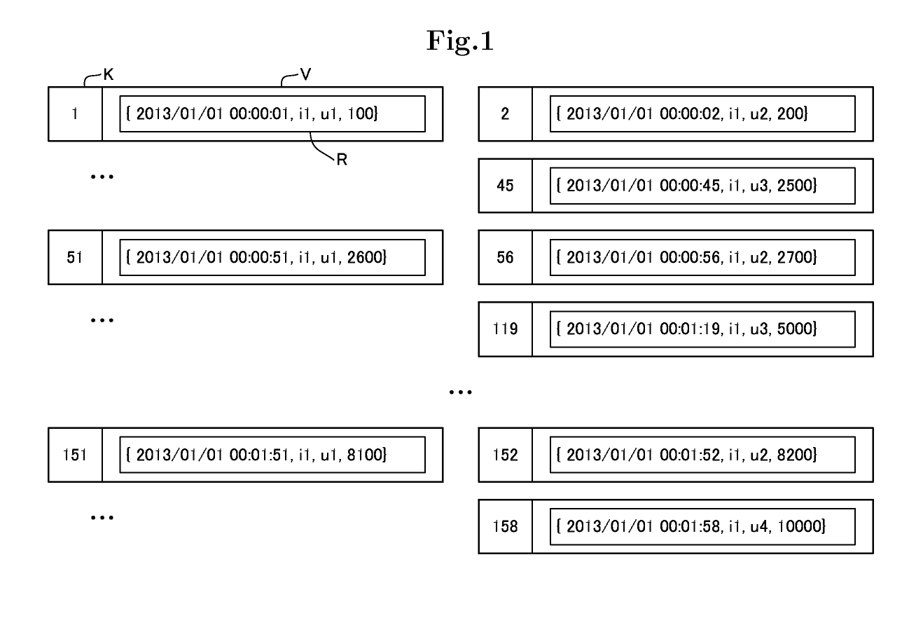

FIG. 2 is a diagram showing an exemplary data structure of key-value store related to the present invention;

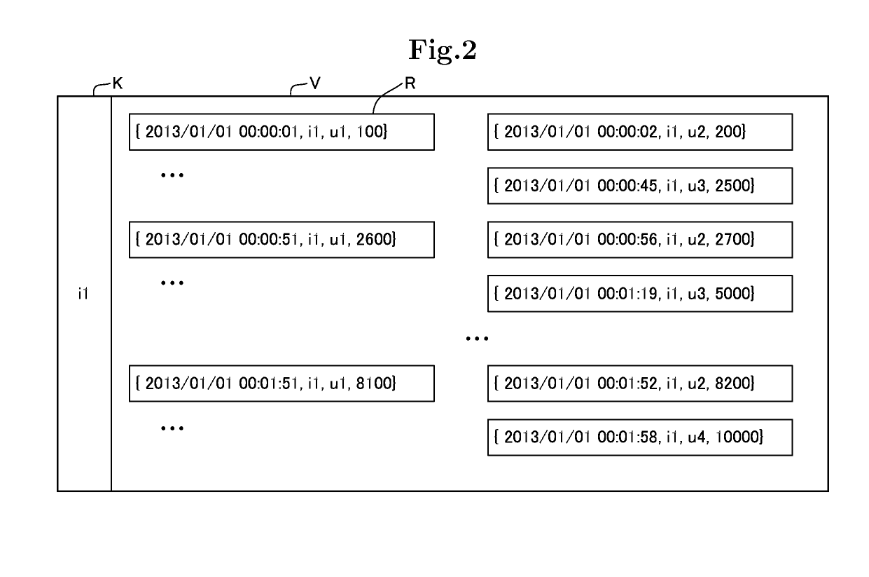

FIG. 3 is a block diagram showing a configuration of an information processing system according to a first exemplary embodiment of the present invention;

FIG. 4 is a diagram showing exemplary data to be processed in the information processing system according to the first exemplary embodiment of the present invention;

FIG. 5 is a diagram showing exemplary data to be processed in the information processing system according to the first exemplary embodiment of the present invention;

FIG. 6 is a diagram showing exemplary data to be processed in the information processing system according to the first exemplary embodiment of the present invention;

FIG. 7 is a diagram showing exemplary data to be processed in the information processing system according to the first exemplary embodiment of the present invention;

FIG. 8 is a flowchart showing operation performed by the information processing system according to the first exemplary embodiment of the present invention;

FIG. 9 is a flowchart showing operation performed by the information processing system according to the first exemplary embodiment of the present invention;

FIG. 10 is a block diagram showing a configuration of an information processing system according to a second exemplary embodiment of the present invention;

FIG. 11 is a diagram showing exemplary data to be processed in an information processing system according to a third exemplary embodiment of the present invention; and

FIG. 12 is a diagram showing a configuration of an information processing system according to supplementary note 1 of the present invention.

### EXEMPLARY EMBODIMENTS

### First Exemplary Embodiment

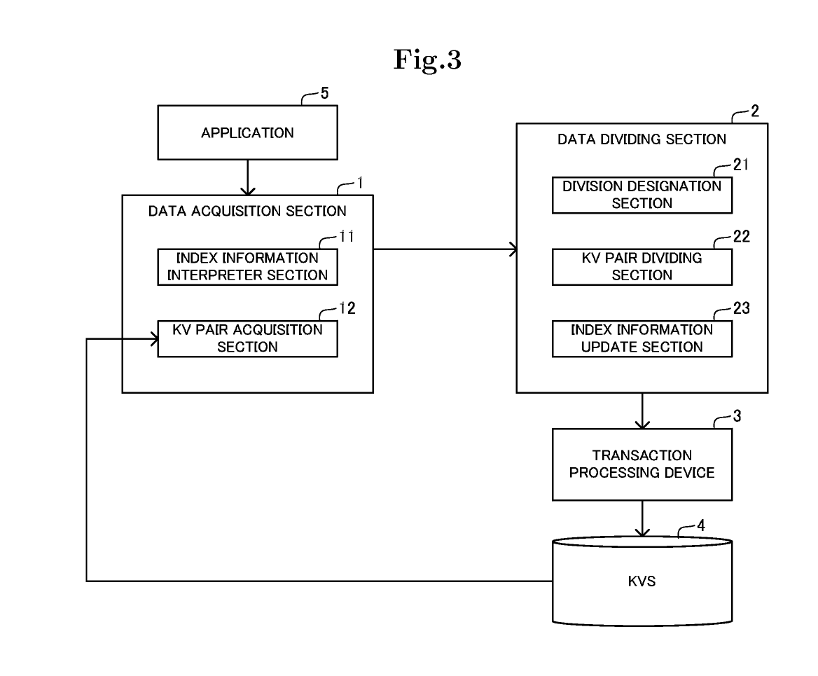

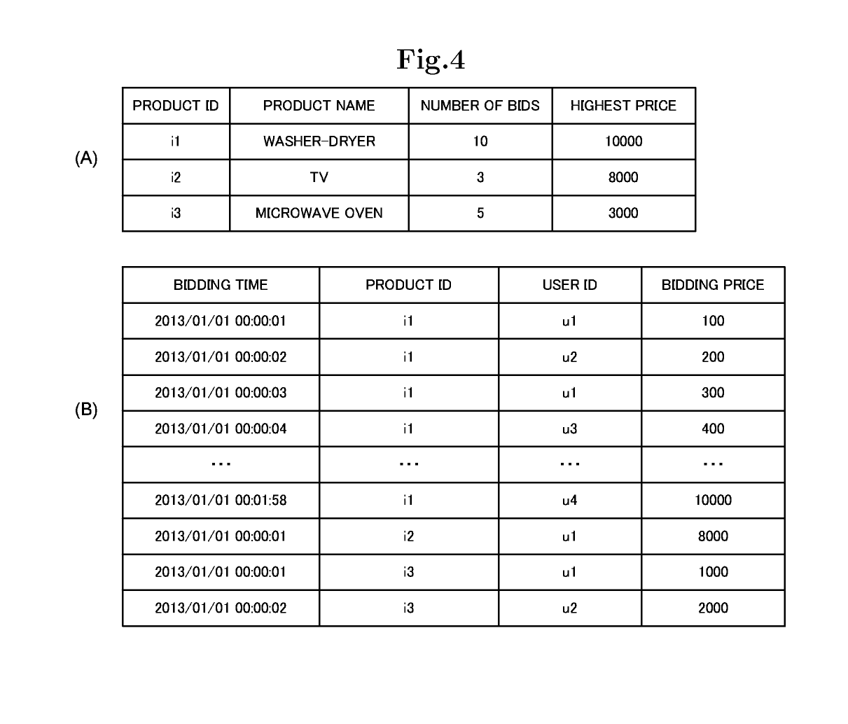

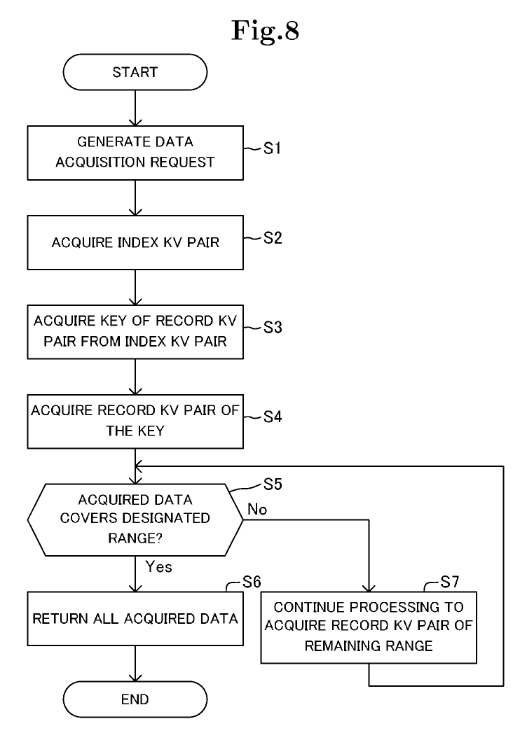

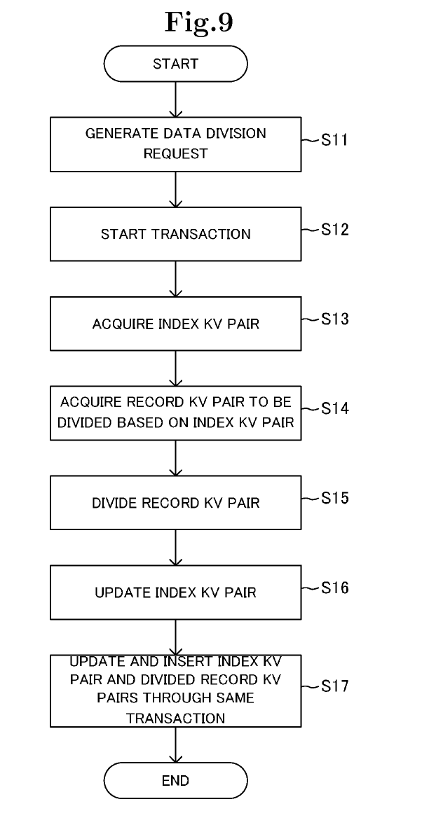

A first exemplary embodiment of the present invention will be described with reference to FIGS. 3 to 9. FIG. 3 is a block diagram showing a configuration of an information processing system. FIGS. 4 to 7 are diagrams showing exemplary data to be processed in the information processing system. FIGS. 8 and 9 are flowcharts showing operation of the information processing system.

### [Configuration]

An information processing device in the first exemplary embodiment includes a KVS (Key-Value Store) 4 which is a storage device for storing data to be processed. The information processing system includes a transaction processing device 3 which is linked to the KVS 4 and stores data in the KVS 4 through transaction processing. The information processing system also includes an application 5 which makes a data acquisition request, a data acquisition section 1 which acquires data from the KVS 4 in response to a request from the application 5, and a data dividing section 2 which divides data and stores the data in the KVS 4 via the transaction processing device 3.

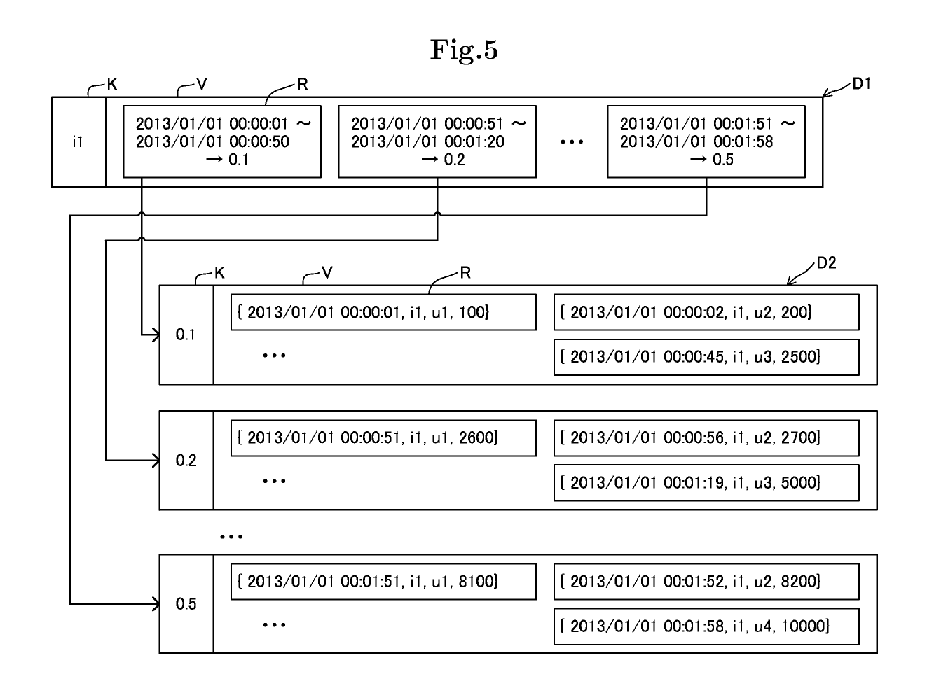

The data dividing section 2 (data management unit) includes a division designation section 21, a KV pair dividing section 22, and an index information update section 23, which are constructed by installing programs in the arithmetic unit provided to the information processing system. First, as a basic function, the data dividing section 2 has a function of storing data in the KVS 4, in a data structure of a combination of an index KV pair D1 and a record KV pair D2 as shown in FIG. 5.

Here, the data structure of data to be stored in the KVS 4 will be described. The original data to be stored in the KVS 4 is a group of records of data representing bidding states with respect to products, as shown in FIG. 4. For example, as shown in FIG. 4(A), when a bid is made to a product having a product ID, the bidding time, the product ID, the user ID of the bidder, and the bidding price are recorded as shown in FIG. 4(B). Here, the bidding time, the product ID, the user ID, and the bidding price are respectively attributes constituting a record, and each record is configured to have the value of each attribute. Then, the data dividing section 2 stores the data, showing the above-described bidding state, in the KVS 4 in the data structure shown in FIG. 5.

The data structure to be stored in the KVS 4 is expressed as a combination of the index KV pair D1 and the record KV pair D2, as described above (see FIG. 5). The record KV pair D2 is a KV pair (key-value pair) having a value V in which a plurality of records R are put together, and a given key K is associated with the value V. Here, a rule for putting together a plurality of records constituting the value V of the record KV pair D2 is as described below.

First, among a group of records shown in FIG. 3(B), a value of one attribute is determined as a cluster key which is a representative key. In this example, if an attribute “product ID” is determined as a cluster key, a plurality of records having the same attribute as the cluster key are put together as one KV pair. This means that the value V of the record KV pair D2 is formed by putting together some records having the same attribute, namely “product ID”.

The value V of the record KV pair D2 is configured by putting together records within each responsible range of values of a range key which is a predetermined attribute. For example, in the example of FIG. 5, for each record KV pair D2, a responsible range (classification reference value) for classifying the “bidding time”, serving as a range key, by each period of time in a predetermined range is set, and a plurality of records R corresponding to the responsible range, set for each record KV pair D2, are included as the value V. Here, it is assumed that responsible ranges of the range key are set so as not to overlap each other, by each value of the cluster key. As the key K of each record KV pair D2, a value is determined uniquely (for example, in the example of FIG. 5, 0.1, 0.2, or the like) corresponding to the responsible range of the range key set to each record KV pair D2, and is set thereto.

The index KV pair D1 is a KV pair (key-value pair) having a value V which includes the values in the responsible range of the range key, set to each record KV pair D2, as records R, in which the cluster key is associated with the value V as the key K. It should be noted that the value V include values of one or a plurality of responsible ranges (classification reference values), and that each of the responsible ranges is associated with the key K of the corresponding record KV pair D2. For example, the index KV pair D1 of the example shown in FIG. 5 is an index of records representing bidding states of a product having the value of the attribute “product ID” being “i1”, in which “i1” is set as the key K, and as the records R of the value V, a plurality of responsible ranges of the attribute “bidding time” are included. Further, the respective responsible ranges included in the value V are associated with the keys K (0.1, 0.2, and the like) of the respective KV pairs D2, respectively.

As described above, the data dividing section 2 generates mutually associated KV pair shaving the data structure described above, and stores them in the KVS 4. It should be noted that when storing mutually associated KV pairs in the KVS 4, the data dividing section 2 stores then through the same transaction processing via the transaction processing device 3 which will be described below.

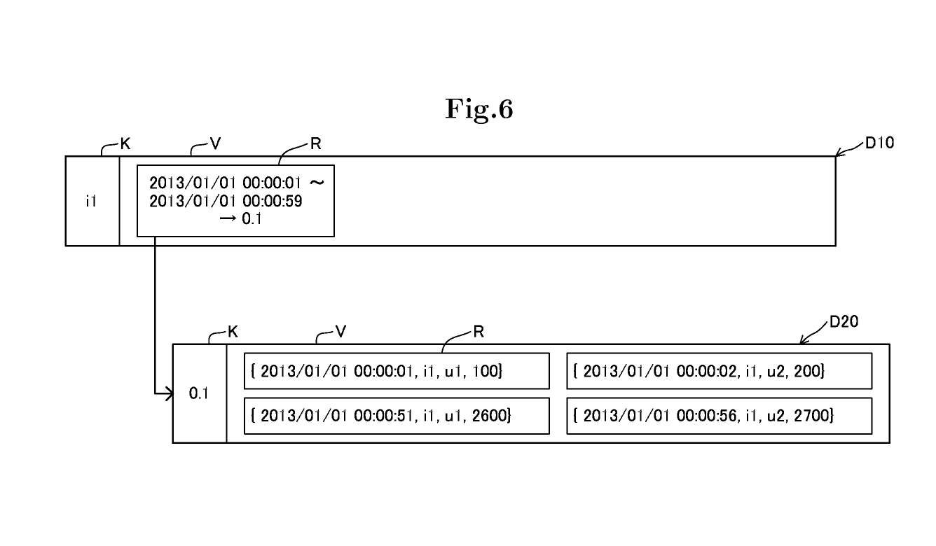

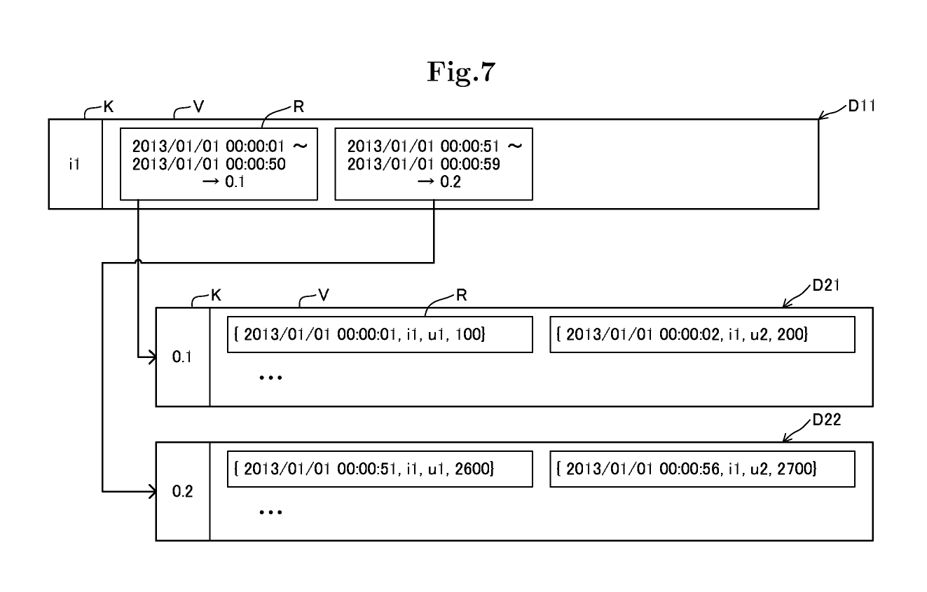

Further, the data dividing section 2 has a function of dividing the record KV pair D2 and updating the index KV pair D1. Division of a KV pair will be described with reference to FIGS. 6 and 7. In this example, description will be given on the case where a KV pair, shown in FIG. 6, is divided as shown in FIG. 7.

The division designation section 21 determines whether or not to divide a KV pair. For example, the division designation section 21 determines to divide a record KV pair D20, shown in FIG. 6, if the size or the number of records R of the record KV pair D20 becomes a predetermined threshold or larger.

If the division designation section 21 determines to divide, the division designation section 21 determines how to divide the responsible ranges of the values of the range key. For example, as shown in FIG. 7, responsible ranges of the values of the range key are determined such that the number of records included in respective record KV pairs D21 and D22 after the division becomes the same or almost the same (same according to a predetermined criterion), or the size of them becomes the same or almost the same (same according to a predetermined criterion). In this example, the bidding time “2013/01/01 00:00:01˜2013/01/01 00:00:59”, which is the responsible range before the division as shown in FIG. 6, is divided into responsible ranges “2013/01/01 00:00:01˜2013/01/01 00:00:50” and “2013/01/01 00:00:51˜2013/01/01 00:00:59”.

Then, based on the newly determined responsible ranges as described above, the KV pair dividing section 22 newly creates the record KV pair D22 as shown in FIG. 7, and allocates records in the source record KV pair D21, from which the division is made, to the new record KV pair D22. Then, the KV pair dividing section 22 sets an appropriate key to the newly created record KV pair D22. In this step, the key of the record KV pair D21, which is the source of the division, is reused, and the key of the record KV pair D22, added by the division, is numbered. While any numbering method can be used, a numbering device for managing keys may be introduced, or other methods described below may be used.

The index information update section 23 updates the index KV pair D11 so as to refer to the record KV pairs D21 and D22 which have been newly created as described above. This means that the index information update section 23 updates the value of the index KV pair D21 to have responsible ranges of the divided range key as described above, and associates the respective responsible ranges with the respective keys of the record KV pairs D21 and D22.

The transaction processing device 3 stores the KV pairs created by the data dividing section 2 as described above, that is, the index KV pair and the record KV pair having been put together, in the KVS 4 through the same transaction processing. It should be noted that processing of storing a plurality of associated KV pairs through the same transaction processing can be realized by the method disclosed in “JP 2012-238061 A (hereinafter referred to as Related Document 1)”, or may be realized by another method.

Next, the data acquisition section 1 which acquires data stored in the KVS 4 as described above will be described in detail. The data acquisition section 1 (data acquisition unit) includes an index information interpreter section 11 and a KV pair acquisition section 12, which are constructed by installing a program in the arithmetic unit provided to the information processing system. The data acquisition section 1 interprets a request from the application 5, and returns the requested data in association with the KV pair acquisition section 12 and the index information interpreter section 11.

Specifically, in order to acquire a KV pair requested by the application 5, the data acquisition section 1 makes a data acquisition request to the KV pair acquisition section 12. It is assumed that the date acquisition request designates a “key of the cluster key” and a “range of the range key”. Then, the KV pair acquisition section 12 acquires an index KV pair having the requested “key of the cluster key” from the KVS 4, and the acquired index KV pair is interpreted by the index information interpreter section 11, whereby the key of the record KV pair corresponding to the responsible range, in which the requested “range of the range key” is included, is acquired. Then, based on the key of the record KV pair acquired by the index information interpreter section 11, the KV pair acquisition section 12 acquires the record KV pair, in which records are stored, from the KVS 4, and returns the acquired record KV pair to the application 5.

It should be noted that the information processing system according to the present embodiment is configured of one or a plurality of information processing devices. As an example, the information processing system shown in FIG. 3 is configured of a plurality of information processing devices, in which the application 5, the data acquisition section 1, the data dividing section 2, the transaction processing device 3, and the KVS 4 are configured of separate information processing devices, respectively.

### [Operation]

Next, operation of the information processing system having the above-described configuration will be described. First, operation of acquiring data from the KVS will be described with reference to FIG. 8. Further, operation of dividing a record KV pair will be described with reference to FIG. 9. Furthermore, operation of acquiring data in a log, which is not stored in the KVS, will also be described.

First, operation of acquiring data from the KVS will be described. It should be noted that in this example, it is assumed that KV pairs, having the data structure shown in FIG. 5, are stored in the KVS 4.

First, the application 5 issues a data acquisition request designating a “key of the cluster key” and a “range of the range key”, to the data acquisition section 1 (step S1). In this step, it is assumed that a data acquisition request in which a key of the cluster key is “i1” and a range of the range key is “2013/01/01 00:00:51˜2013/01/01 00:00:59” is issued.

Then, the KV pair acquisition section 12 uses the designated key “i1” of the cluster key to acquire the corresponding index KV pair D1 from the KVS 4 (step S2). Then, the index information interpreter section 11 interprets the index KV pair D1 acquired by the KV pair acquisition section 12, and acquires the key of a record KV pair D2 in which a record including the “range of the range key” designated in the data acquisition request is stored (step S3). According to the index KV pair D1 in FIG. 5, it is found that data of the“2013/01/01 00:00:51˜2013/01/01 00:00:59”, designated in the data acquisition request, is stored in a record KV pair D2 having a key “0.2”. Then, based on the key “0.2” of the record KV pair D2 acquired by the index information interpreter section 11, the KV pair acquisition section 12 acquires the corresponding record KV pair D2 from the KVS 4 (step S4).

It should be noted that if there are a plurality of keys acquired by the index information interpreter section 11, the KV pair acquisition section 12 acquires a plurality of record KV pairs D2 corresponding to the number of the keys (No at step S5, step S7).

Then, when the data acquisition section 1 acquires all of the record KV pairs D2 in the “range of the range key” according to the data acquisition request by the KV pair acquisition section 12 (Yes at step S5), the data acquisition section 1 returns the acquired record KV pairs D2 to the application 5 (step S6).

Next, operation of dividing a KV pair will be described. In this example, it is assumed that the KV pair shown in FIG. 6 is divided as shown in FIG. 7.

First, the application 5 issues a request for dividing a record KV pair while designating a “key of the cluster key” and a “range of the range key” (step S11). Then, based on the request from the application 5, the transaction processing device 3 performs transaction start processing (step S12) (this processing is similar to the transaction start processing described in Related Document 1 mentioned above).

Subsequently, the KV pair acquisition section 12 acquires an index KV pair D10 from the KVS 4 based on the designated “key of the cluster key” (step S13). Then, based on the designated “range of the range key”, the index information interpreter section 11 acquires the key of a record KV pair D20 including records in the “range of the range key” designated by the acquired index KV pair D10. Based on the key acquired by the index information interpreter section 11, the KV pair acquisition section 12 acquires the record KV pair D20, which is the division target, from the KVS 4 (step S14). Then, the data acquisition section 1 delivers the record KV pair D20, acquired by the KV pair acquisition section 12, to the data dividing section 2.

Subsequently, the division designation section 21 of the data dividing section 2 determines whether or not to divide the record KV pair D20. Determination of division is made in such a manner that the record KV pair D20 is divided if the size of the record KV pair D20 becomes a predetermined threshold or larger. It should be noted that division can be determined by any manners, and division may be made if the number of records included in the record KV pair D20 becomes a predetermined threshold or larger. If division has been determined, it is determined how to divide the responsible range of the range key. For example, responsible ranges of the range key are determined such that the number of records included in respective record KV pairs after the division becomes the same or almost the same (same according to the predetermined criterion). In this example, it is assumed that the bidding time “2013/01/01 00:00:01˜2013/01/01 00:00:59”, which is the responsible range before the division as shown in FIG. 6, is divided into a plurality of responsible ranges “2013/01/01 00:00:01˜2013/01/01 00:00:50” and “2013/01/01 00:00:51˜2013/01/01 00:00:59”.

Then, the KV pair dividing section 22 newly creates a record KV pair D22 as shown in FIG. 7, based on the newly determined responsible range as described above, and allocates records in the source record KV pair D21, from which division was made, to the new record KV pair D22 (step S15). Then, the KV pair dividing section 22 sets an appropriate key to the newly created record KV pair D22. The key of the source record KV pair D21, from which division was made, is reused, and the key of the record KV pair D22, added by the division, is numbered. The data dividing section 2 delivers the newly created record KV pairs D21 and D22 to the transaction processing device 3.

Subsequently, the index information update section 23 updates the index KV pair D11 so as to refer to the record KV pairs D21 and D22 newly created as described above (step S16). This means that the index information update section 23 updates the value of the index KV pair D21 to the responsible ranges of the range key divided as described above, and associates the respective responsible ranges with the keys of the record KV pairs D21 and D22, respectively. The data dividing section 2 delivers the updated index KV pair D11 to the transaction processing device 3.

Subsequently, the transaction processing device 3 performs transaction processing of updating and insertion of the index KV pair D11, delivered from the data dividing section 2, and the record KV pairs D21 and D22. This means that in this step, the index KV pair D11 formed by putting together data relating to the cluster key “i1” and the record KV pairs D21 and D22 are stored in the KVS 4 through the same transaction processing. In this step, the processing of storing the KV pairs through the same transaction can be realized by the method disclosed in Related Document 1 mentioned above.

For example, the transaction processing is performed as follows. First, in a group of data in which consistency should be maintained in the transaction processing, that is, among the logs corresponding to the index KV pair D11 and the record KV pairs D21 and D22 respectively, a log which uses the cluster key “i1”, which is the representative key, as a key is handled as a representative log, and the logs other than the representative log are handled as subordinate logs. Then, in-transaction identification information is added to the subordinate logs to thereby restrict accesses caused by other transactions. Further, update information of each KV pair is written in the representative log, which is written in each KV pair in the KVS 4. In this way, consistency in the related KV pairs can be maintained. It should be noted that a method of writing the KV pairs in the KVS 4 through the transaction processing is not limited to the method described above, and any other methods may be used.

It should be noted that in the present invention, it is necessary to atomically perform update of a plurality of KV pairs consisting of the index KV pair D11 and the record KV pairs D21 and D22, as described above. While such processing can be realized by the method disclosed in Related Document 1 mentioned above, it is necessary to select a “representative key” in the method of Related Document 1. As such, in the present embodiment, it is possible to update a plurality of KV pairs atomically by selecting the attribute value set to the cluster key, among the index KV pair D11 and the record KV pairs D21 and D22, as a “representative key”, as described above.

While description has been given on the case where every data is acquired from the KVS 4, there is a case where some data only exists in the “logs” due to the transaction processing and it cannot be acquired from the KVS 4. In that case, a KV pair is acquired in the following procedures in order to refer to the data only exists in the log.

First, based on a request from the application, the transaction processing device 3 performs transaction start processing. Then, the KV pair acquisition section 12 issues a data acquisition request corresponding to the designated “key of the cluster key”, to the transaction processing device 3.

Then, the transaction processing device 3 checks whether or not data satisfying the request from the KV pair acquisition section 12 exists in the logs. If the corresponding data exists in the logs, the transaction processing device 3 restores the KV pair from the logs. Then, the restored KV pair is delivered from the transaction processing device 3 to the KV pair acquisition section 12. In this case, as delivery of data from the transaction processing device 3 to the KV pair acquisition section 12 occurs, it is preferable that the transaction processing device 3 has a function of restoring data from the logs to the KVS 4.

As described above, according to the information processing device of the present embodiment, related records are put together (in the above-described case, records of the product ID “i1”) and are separated into an index KV pair and record KV pairs, thereby it is possible to acquire necessary records only. Consequently, unnecessary data transfer can be reduced, whereby processing performance can be improved. Further, by further dividing a record KV pair to thereby realize scale out, it is possible to prevent unnecessary data from being acquired, whereby processing performance can be further improved.

Further, by storing a plurality of KV pairs, formed by putting together related records, in the KVS through the same transaction processing, it is possible to ensure consistency and atomicity thereof, whereby data reliability can be improved. Further, as it is possible to operate a plurality of KV pairs, a complicated data structure such as a tree structure can be introduced. Thereby, it is possible to perform atomic data operation designating a value range, for example.

### Second Exemplary Embodiment

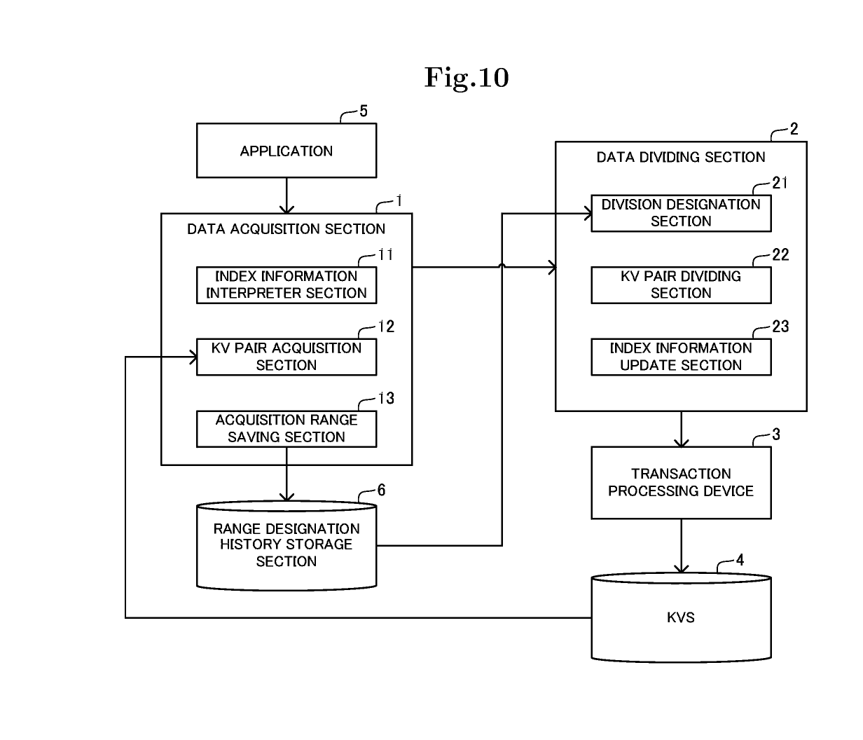

Next, a second exemplary embodiment of the present invention will be described with reference to FIG. 10. An information processing system according to the present embodiment includes the following configuration, in addition to the configuration of the first exemplary embodiment.

As shown in FIG. 10, the information processing system includes a range designation history storage section 6. Further, the data acquisition section 1 includes an acquisition range saving section 13.

The acquisition range saving section 13 accumulates the history of the ranges of the range key designated by the application 5 at the time of data acquisition (retrieval), as described above, in the range designation history storage section 6. Then, the division designation section 11 analyzes the history stored in the range designation history storage section 6 when dividing a record KV pair, and determines how to divide the content of the record KV pair. As a dividing method, a method of dividing data by a boundary value of a range having the highest retrieval (acquisition) frequency may be used, for example. In that case, the record KV pair is divided into a record KV pair including data of the boundary value or smaller, and a record KV pair including data larger than the boundary value.

Here, a specific example of dividing a record KV pair will be described.

For example, it is assumed that records are stored in respective record KV pairs as shown in (1) and (2) below.

(1) [{2013/01/01 00:00:51, i1, . . . }, {2013/01/01 00:00:54, i1, . . . }, {2013/01/01 00:00:58, i1, . . . }, {2013/01/01 00:01:01, i1, . . . }]
(2) [{2013/01/01 00:01:25, i1, . . . }, {2013/01/01 00:01:28, i1, . . . }]

Then, consideration is given to the case where a range of “2013/01/01 00:01:00˜2013/01/01 00:02:00” is frequently designated as an acquisition request (retrieval request) from the application. In this case, the record KV pair in (1) is divided into record KV pairs of (1-1) and (1-2) as shown below. Thereby, it is possible to prevent unnecessary data of (1-1), in a range other than the range which is frequently designated as retrieval request, from being acquired from the KVS 4, whereby processing efficiency can be improved.

(1-1) [{2013/01/01 00:00:51, i1, . . . }, {2013/01/01 00:00:54, i1, . . . }, {2013/01/01 00:00:58, i1, . . . }]
(1-2) [{2013/01/01 00:01:01, i1, . . . }]
(2) [{2013/01/01 00:01:25, i1, . . . }, {2013/01/01 00:01:28, i1, . . . }]

### Third Exemplary Embodiment

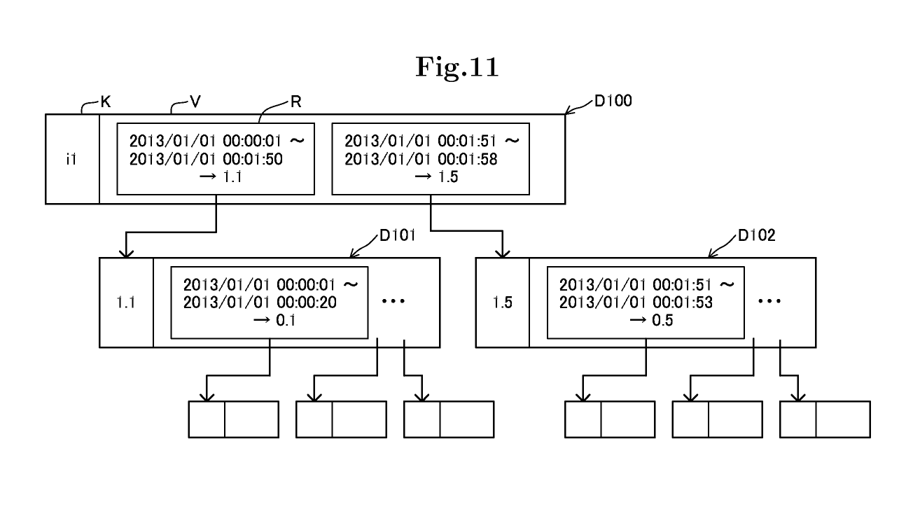

Next, a third exemplary embodiment of the present invention will be described with reference to FIG. 11. An information processing system according to the present embodiment includes the following configuration, in addition to the configuration of the first exemplary embodiment or the second exemplary embodiment.

The data dividing section 2 of the present embodiment has a function of not only dividing a record KV pair as described above, but also dividing an index KV pair. For example, as shown in FIG. 11, if there is an index KV pair D100, the data dividing section 2 divides each responsible range of the range key, which is a record included in the value of the index KV pair D100, into index KV pairs D101 and D102. Specifically, in the example of FIG. 11, keys “1.1” and “1.5” are associated with the bidding times “2013/01/01 00:00:01˜2013/01/01 00:01:50” and “2013/01/01 00:01:51˜2013/01/01 00:01:58” which are responsible ranges respectively, to thereby generate index KV pairs D101 and D102. Then, as the value of each of the index KV pairs D101 and D102, a further divided responsible range is set, and the divided responsible range is associated with a record KV pair including the corresponding records.

In this way, by dividing an index KV pair, it is possible to acquire only desired records more reliably, whereby processing efficiency can be further improved.

### Fourth Exemplary Embodiment

Next, a fourth exemplary embodiment of the present invention will be described. While an information processing system of the present embodiment has almost the same configuration as that of any of the first to third exemplary embodiments described above, in addition thereto, the information processing system of the present embodiment also has a function of setting a key of a KV pair generated by division, as described below.

For example, in the case where there are KV pairs having keys “0.0” and “1.0”, it is assumed that the KV pair having the key “0.0” is divided. In this case, an intermediate value, that is, (0.0+1.0)/2=0.5, is set as a new key. In this way, by using an intermediate value of the existing keys as a new key, it is possible to perform division without interrupting parallel processing of the distributed system. Although a case where a KV pair is divided and keys compete with each other may occur even in another processing, such a case is a conflict in transaction processing in the first place. As such, there is no need to consider it.

### <Supplementary Notes>

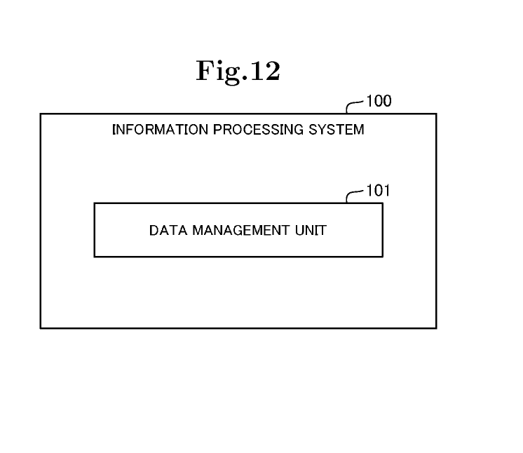

The whole or part of the exemplary embodiments disclosed above can be described as, but not limited to, the following supplementary notes. Hereinafter, the outline of the configurations of an information processing system 100 (see FIG. 12), a program, a data management method, according to the present invention, will be described. However, the present invention is not limited to the configurations described below.

### (Supplementary Note 1)

An information processing system 100 comprising

a data management unit 101 that manages a group of records having a plurality of attribute values in a data structure including an index key-value pair and a record key-value pair associated with each other, wherein

the data management unit 101 generates the index key-value pair including a value including a classification reference value indicating a criterion for classifying given attribute values included in the group of records, and a key associated with the value, and also generates the record key-value pair including a key associated with the classification reference value in the value of the index key-value pair, and a value including information of the records having the given attribute values corresponding to the classification reference value.

### (Supplementary Note 2)

The information processing system according to supplementary note 1, wherein

the data management unit divides the information of the records included in the record key-value pair into a plurality of values corresponding to the given attribute values included in the information of the records, in accordance with a plurality of classification reference values newly set, generates a plurality of record key-value pairs each including a divided value and a key associated with the value, updates the value of the index key-value pair to the classification reference values newly set, and associates each of the classification reference values and the key of each of the generated record key-value pairs.

### (Supplementary Note 3)

The information processing system according to supplementary note 2, wherein

the data management unit divides the record key-value pair if a data size or the number of records of the record key-value pair is a predetermined threshold or larger.

### (Supplementary Note 3-1)

The information processing system according to supplementary note 2 or 3, wherein

the data management unit divides the record key-value pair in such a manner that the record key-value pairs after the division have the same data size or the same number of records.

### (Supplementary Note 4)

The information processing system according to any of supplementary notes 1 to 3, further comprising

a data acquisition unit that acquires the record key-value pair from a storage device that stores the index key-value pair and the record key-value pair, wherein

the data acquisition unit accepts a retrieval request designating a key of the index key-value pair and the classification reference value, and acquires, from the storage device, the record key-value pair including a key associated with the classification reference value satisfying the classification reference value designated in the retrieval request, in the index key-value pair including the key designated in the retrieval request.

### (Supplementary Note 5)

The information processing system according to supplementary note 4, wherein

the data acquisition unit accumulates the classification reference value accepted as the retrieval request, and

the data management unit generates the record key-value pair according to the classification reference value accumulated by the data acquisition unit.

### (Supplementary Note 6)

The information processing system according to supplementary note 2 or 3, further comprising

a data acquisition unit that acquires the record key-value pair from a storage device that stores the index key-value pair and the record key-value pair, wherein

the data acquisition unit accepts a retrieval request designating a key of the index key-value pair and the classification reference value, acquires, from the storage device, the record key-value pair including a key associated with the classification reference value satisfying the classification reference value designated in the retrieval request, in the index key-value pair including the key designated in the retrieval request, and accumulates the classification reference value accepted as the retrieval request, and

the dividing unit divides the record key-value pair according to a classification reference value in which the retrieval requests have been made most frequently, among the classification reference values accumulated by the data acquisition unit.

### (Supplementary Note 7)

The information processing system according to any of supplementary notes 1 to 6, wherein

the data management unit stores, in a storage device, the index key-value pair and the record key-value pair having the key associated with the classification reference value included in the value of the index key-value pair, through the same transaction processing.

### (Supplementary Note 8)

The information processing system according to supplementary note 7, wherein

the data management unit selects one of the attribute values included in the records as a representative key, and performs the transaction processing with use of a log of a key-value pair in which the representative key serves as a key of the key-value pair.

### (Supplementary Note 9)

A program for causing an information processing device to realize

a data management unit that manages a group of records having a plurality of attribute values in a data structure including an index key-value pair and a record key-value pair associated with each other, wherein

the data management unit generates the index key-value pair including a value including a classification reference value indicating a criterion for classifying given attribute values included in the group of records, and a key associated with the value, and also generates the record key-value pair including a key associated with the classification reference value in the value of the index key-value pair, and a value including information of the records having the given attribute values corresponding to the classification reference value.

### (Supplementary Note 9-1)

The program according to supplementary note 9, wherein

the data management unit divides the information of the records included in the record key-value pair into a plurality of values corresponding to the given attribute values included in the information of the records, in accordance with a plurality of classification reference values newly set, generates a plurality of record key-value pairs each including a divided value and a key associated with the value, updates the value of the index key-value pair to the classification reference values newly set, and associates each of the classification reference values and the key of each of the generated record key-value pairs.

### (Supplementary Note 9-2)

The program according to supplementary note 9 or 9-1, further causing the information processing device to realize

a data acquisition unit that acquires the record key-value pair from a storage device that stores the index key-value pair and the record key-value pair, wherein

the data acquisition unit accepts a retrieval request designating a key of the index key-value pair and the classification reference value, and acquires, from the storage device, the record key-value pair including a key associated with the classification reference value satisfying the classification reference value designated in the retrieval request, in the index key-value pair including the key designated in the retrieval request.

### (Supplementary Note 9-3)

The program according to any of supplementary notes 9 to 9-2, wherein

the data management unit stores, in a storage device, the index key-value pair and the record key-value pair having the key associated with the classification reference value included in the value of the index key-value pair, through the same transaction processing.

### (Supplementary Note 10)

A data management method comprising:

in an information processing device, when managing a group of records having a plurality of attribute values in a data structure including an index key-value pair and a record key-value pair associated with each other,

generating the index key-value pair including a value including a classification reference value indicating a criterion for classifying given attribute values included in the group of records, and a key associated with the value, and

also generating the record key-value pair including a key associated with the classification reference value in the value of the index key-value pair, and a value including information of the records having the given attribute values corresponding to the classification reference value.

### (Supplementary Note 10-1)

The data management method according to Claim 10, further comprising:

dividing the information of the records included in the record key-value pair into a plurality of values corresponding to the given attribute values included in the information of the records, in accordance with a plurality of classification reference values newly set;

generating a plurality of record key-value pairs each including a divided value and a key associated with the value;

updating the value of the index key-value pair to the classification reference values newly set; and

associating each of the classification reference values and the key of each of the generated record key-value pairs.

### (Supplementary Note 10-2)

The data management method according to supplementary note 10 or 10-1, further comprising:

when acquiring the record key-value pair from a storage device that stores the index key-value pair and the record key-value pair,

accepting a retrieval request designating a key of the index key-value pair and the classification reference value, and

acquiring, from the storage device, the record key-value pair including a key associated with the classification reference value satisfying the classification reference value designated in the retrieval request, in the index key-value pair including the key designated in the retrieval request.

### (Supplementary Note 10-3)

The data management method according to any of supplementary notes 10 to 10-2, further comprising:

storing, in a storage device, the index key-value pair and the record key-value pair having the key associated with the classification reference value included in the value of the index key-value pair, through the same transaction processing.

It should be noted that the above-described program is stored in a storage device, or on a computer-readable medium. For example, a medium is a portable medium such as a flexible disk, an optical disk, a magneto-optical disk, a semiconductor memory, or the like.

While the present invention has been described with reference to the exemplary embodiments described above, the present invention is not limited to the above-described embodiments. The form and details of the present invention can be changed within the scope of the present invention in various manners that can be understood by those skilled in the art.

1. An information processing system comprising
a data management unit that manages a group of records having a plurality of attribute values in a data structure including an index key-value pair and a record key-value pair associated with each other, wherein
the data management unit generates the index key-value pair including a value including a classification reference value indicating a criterion for classifying given attribute values included in the group of records, and a key associated with the value, and also generates the record key-value pair including a key associated with the classification reference value in the value of the index key-value pair, and a value including information of the records having the given attribute values corresponding to the classification reference value.

2. The information processing system according to claim 1, wherein
the data management unit divides the information of the records included in the record key-value pair into a plurality of values corresponding to the given attribute values included in the information of the records, in accordance with a plurality of classification reference values newly set, generates a plurality of record key-value pairs each including a divided value and a key associated with the value, updates the value of the index key-value pair to the classification reference values newly set, and associates each of the classification reference values and the key of each of the generated record key-value pairs.

3. The information processing system according to claim 2, wherein
the data management unit divides the record key-value pair if a data size or the number of records of the record key-value pair is a predetermined threshold or larger.

4. The information processing system according to claim 1, further comprising
a data acquisition unit that acquires the record key-value pair from a storage device that stores the index key-value pair and the record key-value pair, wherein
the data acquisition unit accepts a retrieval request designating a key of the index key-value pair and the classification reference value, and acquires, from the storage device, the record key-value pair including a key associated with the classification reference value satisfying the classification reference value designated in the retrieval request, in the index key-value pair including the key designated in the retrieval request.

5. The information processing system according to claim 4, wherein
the data acquisition unit accumulates the classification reference value accepted as the retrieval request, and
the data management unit generates the record key-value pair according to the classification reference value accumulated by the data acquisition unit.

6. The information processing system according to claim 2, further comprising
a data acquisition unit that acquires the record key-value pair from a storage device that stores the index key-value pair and the record key-value pair, wherein
the data acquisition unit accepts a retrieval request designating a key of the index key-value pair and the classification reference value, acquires, from the storage device, the record key-value pair including a key associated with the classification reference value satisfying the classification reference value designated in the retrieval request, in the index key-value pair including the key designated in the retrieval request, and accumulates the classification reference value accepted as the retrieval request, and
the dividing unit divides the record key-value pair according to a classification reference value in which the retrieval requests have been made most frequently, among the classification reference values accumulated by the data acquisition unit.

7. The information processing system according to claim 1, wherein
the data management unit stores, in a storage device, the index key-value pair and the record key-value pair having the key associated with the classification reference value included in the value of the index key-value pair, through the same transaction processing.

8. The information processing system according to claim 7, wherein
the data management unit selects one of the attribute values included in the record as a representative key, and performs the transaction processing with use of a log of a key-value pair in which the representative key serves as a key of the key-value pair.

9. A non-transitory computer readable medium storing a program comprising instructions for causing an information processing device to realize
a data management unit that manages a group of records having a plurality of attribute values in a data structure including an index key-value pair and a record key-value pair associated with each other, wherein
the data management unit generates the index key-value pair including a value including a classification reference value indicating a criterion for classifying given attribute values included in the group of records, and a key associated with the value, and also generates the record key-value pair including a key associated with the classification reference value in the value of the index key-value pair, and a value including information of the records having the given attribute values corresponding to the classification reference value.

10. The non-transitory computer readable medium storing the program according to claim 9, wherein
the data management unit divides the information of the records included in the record key-value pair into a plurality of values corresponding to the given attribute values included in the information of the records, in accordance with a plurality of classification reference values newly set, generates a plurality of record key-value pairs each including a divided value and a key associated with the value, updates the value of the index key-value pair to the classification reference values newly set, and associates each of the classification reference values and the key of each of the generated record key-value pairs.

11. The non-transitory computer readable medium storing the program according to claim 9, further comprising instructions for causing the information processing device to realize
a data acquisition unit that acquires the record key-value pair from a storage device that stores the index key-value pair and the record key-value pair, wherein
the data acquisition unit accepts a retrieval request designating a key of the index key-value pair and the classification reference value, and acquires, from the storage device, the record key-value pair including a key associated with the classification reference value satisfying the classification reference value designated in the retrieval request, in the index key-value pair including the key designated in the retrieval request.

12. The non-transitory computer readable medium storing the program according to claim 9, wherein
the data management unit stores, in a storage device, the index key-value pair and the record key-value pair having the key associated with the classification reference value included in the value of the index key-value pair, through the same transaction processing.

13. A data management method comprising:
in an information processing device, when managing a group of records having a plurality of attribute values in a data structure including an index key-value pair and a record key-value pair associated with each other,
generating the index key-value pair including a value including a classification reference value indicating a criterion for classifying given attribute values included in the group of records, and a key associated with the value, and
also generating the record key-value pair including a key associated with the classification reference value in the value of the index key-value pair, and a value including information of the records having the given attribute values corresponding to the classification reference value.

14. The data management method according to claim 13, further comprising:
dividing the information of the records included in the record key-value pair into a plurality of values corresponding to the given attribute values included in the information of the records, in accordance with a plurality of classification reference values newly set;
generating a plurality of record key-value pairs each including a divided value and a key associated with the value;
updating the value of the index key-value pair to the classification reference values newly set; and
associating each of the classification reference values and the key of each of the generated record key-value pairs.

15. The data management method according to claim 13, further comprising:
when acquiring the record key-value pair from a storage device that stores the index key-value pair and the record key-value pair,
accepting a retrieval request designating a key of the index key-value pair and the classification reference value, and
acquiring, from the storage device, the record key-value pair including a key associated with the classification reference value satisfying the classification reference value designated in the retrieval request, in the index key-value pair including the key designated in the retrieval request.

16. The data management method according to claim 13, further comprising:
storing, in a storage device, the index key-value pair and the record key-value pair having the key associated with the classification reference value included in the value of the index key-value pair, through the same transaction processing.
